(19) United States
(12) Patent Application Publication
(10) Pub. No.: US 2008/0043291 A1
(43) Pub. Date: Feb. 21, 2008

(54) IMAGE FORMING APPARATUS

(76) Inventors: Atsushi Togami, Kanagawa (JP); Hiroyuki Kawamoto, Kanagawa (JP); Satoshi Ohkawa, Tokyo (JP); Tomoyuki Yoshida, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/757,651

(22) Filed: Jun. 4, 2007

(30) Foreign Application Priority Data
Jul. 4, 2006 (JP) 2006-184779

(51) Int. Cl. H04N 1/04

(52) U.S. Cl. 358/474

(57) ABSTRACT

An image forming apparatus includes a scanning unit that scans documents to produce a first image data and a second image data; a correcting unit that corrects at least one of the first image data and the second image data; and a combining unit that combines raw or corrected first image data and the second image data.

### CROSS-REFERENCE TO RELATED APPLICATIONS

The present document incorporates by reference the entire contents of Japanese priority document, 2006-184779 filed in Japan on Jul. 4, 2006.

### BACKGROUND OF THE INVENTION

1. Field of the Invention

The present invention relates to an image forming apparatus.

2. Description of the Related Art

An image forming apparatus of recent years that deals with digitized image data has an affinity for other devices that deal with digital image data, with a result that the image forming apparatus has a plurality of functions such as a fax function, a scanning function, and a printing function in addition to a copying function. Some of such image forming apparatuses store therein image data, and output the image data when necessary.

The image data accumulated in the image forming apparatus is often stored for some time before outputting the image data. Consequently, the application of the image data or the requirements of the user often change between the time when the image data is stored and when the image data is output, so that sometimes the stored image data is not suitable for the changed applications or requirements.

For example, conventionally, when the output of image data that was once used when the copying function was used is reproduced for fax transmission, sometimes the image data itself is not in the form required for fax transmission, or the quality of the image data is significantly different from what is required for fax transmission even if the image data is in the form required for fax transmission.

In view of the foregoing, some image forming apparatuses are so adapted that the quality of image data stored therein is unified. For example, Japanese Patent Application Laid-Open No. 2003-224716 describes an image processing system in which image data is corrected to have a predetermined image characteristic before the image data is transmitted to other image processing devices.

In the technology described in Japanese Patent Application Laid-Open No. 2003-224716 does not, however, support changes of the user's requirements according to each piece of image data, because the image data is always corrected to have the predetermined image characteristic. Moreover, when image data stored in the image forming apparatus and image data produced by an external device, such as a personal computer (PC), are combined and the combined image data is to be output, an appropriate correction that depends on the contents of the combined image data becomes necessary.

### SUMMARY OF THE INVENTION

It is an object of the present invention to at least partially solve the problems in the conventional technology.

According to an aspect of the present invention, an image forming apparatus includes a scanning unit that scans documents to produce a first image data and a second image data; a correcting unit that corrects at least one of the first image data and the second image data; and a combining unit that combines raw or corrected first image data and the second image data.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an image forming apparatus according to an embodiment of the present invention;

FIG. 2 is a flowchart of an accumulation process performed by the image forming apparatus shown in FIG. 1;

FIG. 3 is a drawing illustrating a correction process performed on image data by a first image-correcting unit shown in FIG. 1;

FIG. 4 is a schematic diagram of exemplary patterns in a reference chart;

FIG. 5 is a flowchart of a combining process performed by the image forming apparatus shown in FIG. 1;

FIG. 6 is a drawing illustrating a correction process performed on image data by a second image-correcting unit shown in FIG. 1;

FIG. 7 is a drawing illustrating a correction process performed on combined image data by the second image-correcting unit;

FIG. 8 is a drawing illustrating a correction process performed on image data by a second image-correcting unit of a second embodiment of the present invention;

FIG. 9 is a drawing illustrating a correction process performed on combined image data by the second image-correcting unit of the second embodiment;

FIG. 10 is a drawing illustrating a correction process performed on image data by a second image-correcting unit of a third embodiment of the present invention;

FIG. 11 is a drawing illustrating a correction process performed on combined image data by the second image-correcting unit of the third embodiment;

FIG. 12 is a drawing illustrating a correction process performed on image data by a second image-correcting unit of a fourth embodiment of the present invention;

FIG. 13 is a drawing illustrating a correction process performed on combined image data by the second image-correcting unit of the fourth embodiment;

FIG. 14 is a drawing illustrating a correction process performed on image data 1 by a second image-correcting unit of a fifth embodiment of the present invention;

FIG. 15 is a drawing illustrating a correction process performed on image data 2 by the second image-correcting unit of the fifth embodiment;

FIG. 16 is a drawing illustrating a correction process performed on combined image data by the second image-correcting unit of the fifth embodiment;

FIG. 17 is a drawing illustrating a correction process performed on image data 1 by a second image-correcting unit of a sixth embodiment of the present invention;

FIG. 18 is a drawing illustrating a correction process performed on image data 2 by the second image-correcting unit of the sixth embodiment; and

FIG. 19 is a drawing illustrating a correction process performed on combined image data by the second image-correcting unit of the sixth embodiment.

### DETAILED DESCRIPTION OF THE PREFERRED EMBODIMENTS

An image forming apparatus according to exemplary embodiments of the present invention includes an image scanning unit that scans an original image and produces image data, an image correcting unit that corrects the image data, and an image combining unit that combines a plurality of pieces of such image data. The image forming apparatus stores the image data scanned by the image scanning unit and image data obtained from external sources. Among the stored image data, the image forming apparatus combines the image data scanned by the image scanning unit and the image data obtained from the external sources, thereby producing the output of the combined image data. During the combination of the image data, the image correcting unit corrects as appropriate the two pieces of image data, whereby the two pieces of image data are appropriately combined. The image combining unit combines the two pieces of image data that have been corrected by the image correcting unit. The output correction of the combined image data is performed again by the image correcting unit, to produce optimum image data for the application of the image data. Then the optimum image data is output.

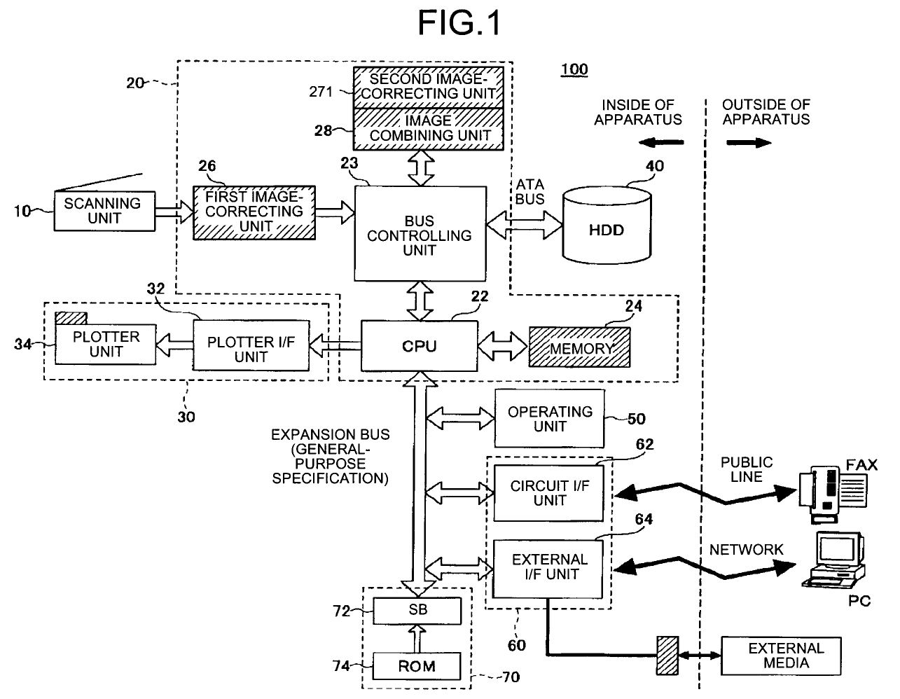

A first embodiment of the present invention will be described by referring to the accompanying drawing. FIG. 1 is a block diagram of an image forming apparatus 100 according to a first embodiment of the present invention.

The image forming apparatus 100 includes a scanning unit 10, an image processing and controlling unit 20, an output unit 30, a hard disk (HDD) 40, an operating unit 50, a communicating unit 60, and a setting retaining unit 70.

Based on a instruction from the operating unit 50 the scanning unit 10 scans a document to produce image data. The image processing and controlling unit 20 performs various processes on the image data. The processed image data can be printed out by using the output unit 30, or can be stored and accumulated in the HDD 40. The image data can also be transmitted via the communicating unit 60 to an external device. The setting retaining unit 70 stores therein settings and computer programs that are used for operating the image forming apparatus 100.

The scanning unit 10 can include a line sensor A/D converter (not shown) including a CCD photoelectric device (not shown) and a drive circuit (not shown). The scanning unit 10 obtains information of contrasting density of original image by scanning the document, thereby producing digital image data of 8-bit each for the RGB three colors.

The image processing and controlling unit 20 corrects the image data produced by the scanning unit 10 in an optimum way that depends on how the image data is to be output. The image data can be output, for example, to the output unit 30 for printing, or can be output to the external device. The image processing and controlling unit 20 includes a central processing unit (CPU) 22, a bus controlling unit 23, a first image-correcting unit 26, a second image-correcting unit 271, an image combining unit 28, and a memory 24.

The CPU 22 is a micro processor that controls the image forming apparatus 100 including the image processing and controlling unit 20. The CPU 22 is, for example, an integrated CPU that incorporates the functions of a typical CPU as well as other functions. The other functions include, for example, functions such as a connecting function to a general purpose interface and a bus connecting function using a crossbar switch.

The bus controlling unit 23 controls a data bus that exchanges image data and various data such as control commands in the image forming apparatus 100 and includes a bridge function between a plurality of bus specifications. The bus controlling unit 23 is connected to the CPU 22, the first image-correcting unit 26, the second image-correcting unit 271, and the image combining unit 28 via a PCI Express bus and is connected to the HDD 40 via an ATA (AT attachment) bus.

The memory 24 is a volatile memory, and stores therein data for temporary exchange thereof in various processes.

The first image-correcting unit 26 corrects the image data so that the image data has a predetermined format or requirement. The image data with the predetermined format or requirement means, for example, that the image data can be output to any of the output unit 30 and the communicating unit 60. The corrections performed in the first image-correcting unit 26 include, for example, gamma conversion for adjusting the brightness of an image, filtering for adjusting the spatial frequency characteristics of the image data, color conversion for converting RGB color space to or from other color spaces, and resolution conversion for adjusting the resolution of the image data. These processes will be described in detail below.

The second image-correcting unit 271 performs correction of the image data corrected in the first image-correcting unit 26 and the image data obtained from the external sources via the communicating unit 60 so that the two image data can be combined appropriately. Appropriately combined means, for example, that the image quality of the image data obtained by combining is the same as that of the original image data corrected in the first image-correcting unit 26. Alternatively, for example, the image quality of the image data obtained by combining is the same as the image quality of the original image data obtained from the external sources.

The second image-correcting unit 271 performs correction of the image data obtained by combining in the image combining unit 28. Such a correction includes, in addition to the various processes performed in the first image-correcting unit 26, halftone processing for adjusting the gradation of the image data. This correction will be described in detail below.

The image combining unit 28 produces combined image data by combining the two image data that have been corrected in the second image-correcting unit 271.

The output unit 30 prints out image data, and it includes a plotter I/F unit 32 and a plotter unit 34. The plotter unit 34 receives corrected image data from the image processing and controlling unit 20 via the plotter I/F unit 32, and prints the image data on a printing medium by an electrophotographic process using laser beams.

The HDD 40 is a large-capacity storage device, for example, used for a desktop computer, and stores and accumulates therein image data. The image data accumulated in the HDD 40 is image data of a standardized color space, such as image data obtained from an external device or an external medium as well as the image data scanned in the scanning unit 10. It is preferable that the HDD 40 is connected to the image processing and controlling unit 20 via an ATA bus.

The operating unit 50 allows the user to operate the image forming apparatus 100, and it includes a display (not shown), such as a liquid crystal display (LCD), and key switches (not shown). The display can be configured to show information such as device status and operation procedures of the image forming apparatus 100. It is preferable that the operating unit 50 is connected to the CPU 22 via a PCI Express bus.

The communicating unit 60 includes a circuit I/F unit 62 and an external I/F unit 64. The circuit I/F unit establishes connection between the PCI Express bus and a public line. The image forming apparatus 100 send data to or receives data from the public line via the circuit I/F unit 62. For example, the image forming apparatus 100 can send a fax to an external fax device via the public line.

The external I/F unit 64 establishes connection between the PCI Express bus and an external device. The image forming apparatus 100 can be connected to a network via the external I/F unit 64, thereby communicating various data with the external device. The image forming apparatus 100 can also be connected to an external medium such as a Secure Digital (SD) card or a Universal Serial Bus (USB) memory via the external I/F unit 64, thereby making it possible to exchange various data with such external media.

The setting retaining unit 70 includes a south bridge (SB) 72 and a read only memory (ROM) 74. The ROM 74 is connected to the image processing and controlling unit 20 via the SB 72. The SB 72 is an electronic device into which a bus bridging function is integrated. The ROM 74 stores therein computer programs and the like executed by the CPU 22 and other devices for implementing various functions provided in the image forming apparatus 100.

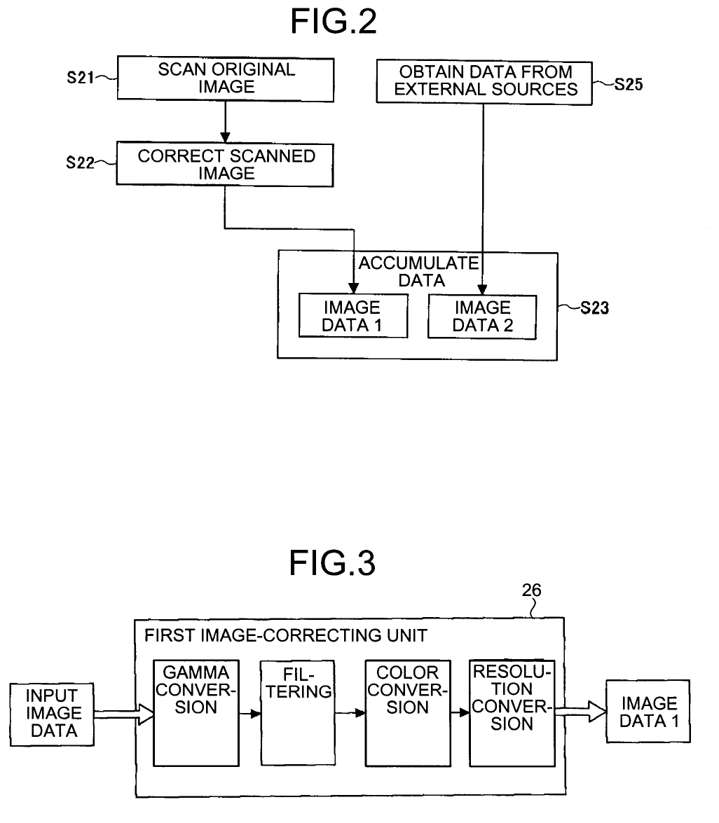

The image data accumulating operation of the image forming apparatus 100 will be described below. FIG. 2 is an example of the image data accumulating operation.

Two types of image data are stored in the HDD 40: the image data obtained by the scanning unit 10, and the image data obtained from the external sources. The image forming apparatus 100 combines those two types of image data in the image data accumulating operation.

More specifically, the scanning unit 10 scans a document thereby obtaining image data (step S21). The first image-correcting unit 26 corrects the scanned image data so that the corrected image data can be output to any of the output unit 30 and the communicating unit 60 (step S22). The corrections performed at step S22 will be described in detail below. The CPU 22 stores and accumulates the corrected image data in the HDD 40 via the bus controlling unit 23 (step S23). The image data that is scanned in the scanning unit 10, corrected in the first image-correcting unit 26, and stored and accumulated will be referred to as image data 1.

On the other hand, when the CPU 22 receives image data from external sources (step S25), it stores and accumulates the received image data in the HDD 40 (step S23). The image data that is obtained from the external sources and accumulated will be referred to as image data 2. The image data 2 may be, for example, image data of a standardized color space.

The correction performed at step S22 will be described in detail below. FIG. 3 is a drawing illustrating an example of the corrections performed by the first image-correcting unit 26.

The first image-correcting unit 26 performs gamma conversion, filtering, color conversion, and resolution conversion to the image data scanned in the scanning unit 10 in the order indicated here.

In the gamma conversion, the first image-correcting unit 26 corrects the gamma characteristic of the image data to a predetermined value. Specifically, the image data is so corrected that the gamma value is equal to 2.2.

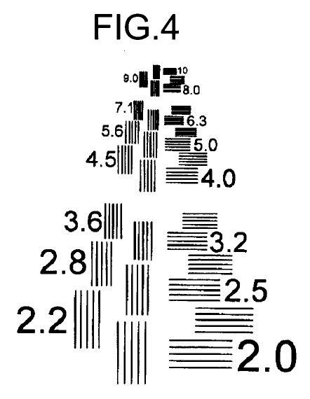

In the filtering, the first image-correcting unit 26 corrects the spatial frequency characteristics of the scanning unit 10 to a predetermined characteristic value. The filtering is so performed that, for example, the spatial frequency characteristics when patterns of a reference chart shown in FIG. 4 are scanned is the same as the spatial frequency characteristics predetermined for each line numbers. FIG. 4 is a schematic drawing of exemplary patterns in a reference chart.

In the color conversion, the first image-correcting unit 26 converts the color space of the image data to a predetermined color space. The predetermined color space is AdobeRGB, which is one of the standardized color spaces, and the color space of the image data scanned in the scanning unit 10 is converted to the AdobeRGB. The color spaces, however, are not limited to the AdobeRGB and that any color spaces are acceptable as long as the color spaces are big enough so that there is no concern for uneven gradation or for being clipped or compressed.

In the resolution conversion, the first image-correcting unit 26 converts the resolution of the image data to a predetermined value. The predetermined resolution is set to be 600 dots per inch (dpi), and the resolution of the image data scanned in the scanning unit 10 is converted to 600 dpi.

In this manner, the first image-correcting unit 26 corrects (converts) the scanned image data to the image data 1 that can be output to any of the output unit 30 and the communicating unit 60.

Combining of the image data and outputting of the combined image data, which are the characteristic operations of the image forming apparatus 100, will be described below.

The image forming apparatus 100 corrects the image data 1 and the image data 2 by performing appropriate correction to produce combined image data. The second image correcting unit 271 then corrects the combined image data and then the corrected-combined image data is output from the image forming apparatus 100.

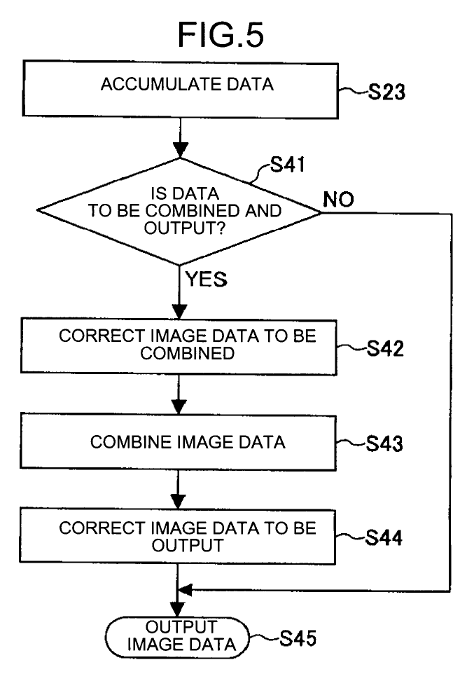

FIG. 5 is a flowchart of a combining process performed by the image forming apparatus 100. To begin with, the image data 1 and the image data 2 are accumulated in the HDD 40 (step S23). When the CPU 22 receives an instruction from the operating unit 50 to combine image data (step S41), it causes the image processing and controlling unit 20 to start a combining process.

It should be noted that information such as a list of each of the image data 1 and 2 that are stored in the HDD 40 may be browsably displayed for the user. The operating unit 50 may enable the user to select from the list a plurality of pieces of image data to be combined. It should be noted that, two pieces of image data in total, each one of which is selected from the image data 1 and 2, are combined.

The CPU 22 reads the image data selected by the user from the HDD 40, and the second image-correcting unit 271 corrects the read image data (step S42). The processes performed at step S42 will be described in detail below.

The image combining unit 28 combines the two image data that have been corrected at step S42, thereby obtaining combined image data (step S43). When combining the two image data, for example, the image combining unit 28 overwrites one piece of the image data with the other. The second image-correcting unit 271 performs correction to the combined image data so that the output is corrected-combined image data that is in accordance with an application of combined image data (step S44). The image forming apparatus 100 outputs the corrected-combined image data (step S45).

The image forming apparatus 100 can be configured to output the image data accumulated at step S23. On the other hand, the image forming apparatus 100 can be configured to perform correction on the accumulated image data and output the corrected image data, that is, not to combine the image data.

Thus, in the image forming apparatus 100, by combining the accumulated image data and by separately correcting each piece of image data to be combined, correction can be performed where alteration of the user's demand for reproduction of the output is supported for each piece of image data. When the combined image data is output, optimum correction according to each piece of image data can be performed.

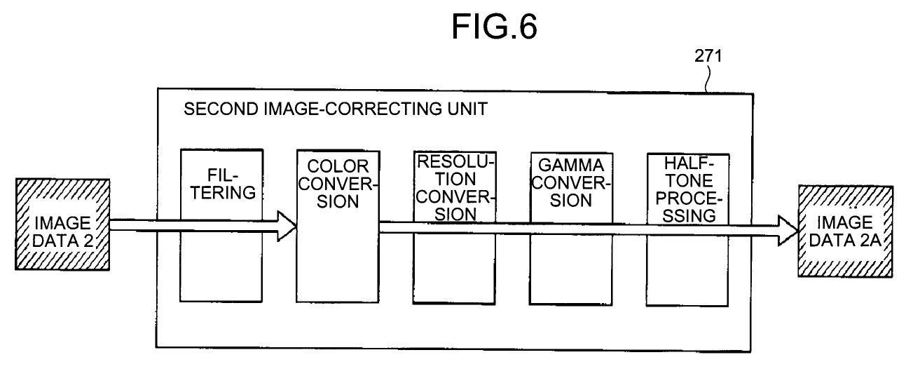

The processes performed at step S42 will be described in detail below. FIG. 6 is a drawing illustrating a correction performed on the image data by the second image-correcting unit 271.

Operations performed by the second image-correcting unit 271 at step S42 include a process with which the image data 1 is so corrected that the image data 1 is in accordance with the image data 2, a process with which the image data 2 is so corrected that the image data 2 is in accordance with the image data 1, and a process with which the image data 1 and 2 are so corrected that the both are in accordance with each other. The corrections of the image data 1 and 2 include color space adjustment, spatial frequency characteristic correction, resolution correction, density correction, background correction, and color correction.

The color space of the image data 2 is so corrected that the color space thereof is similar to that of the image data 1.

In step S22 of FIG. 2, the image data 1 has been so corrected that it has a color space of the AdobeRGB and a resolution of 600 dpi. Consequently, at step S42, the second image-correcting unit 271 corrects the image data 2 to have a color space of the AdobeRGB.

As a result of the corrections at step S42, the image data 2 is converted to image data 2A. This image data 2A is stored temporally in the HDD 40.

The CPU 22 loads the image data 1 and 2A from the HDD 40 to the memory 24, and the image combining unit 28 combined the image data 1 and 2A at step S43. The combining includes overwriting of the image data 1 with the image data 2A.

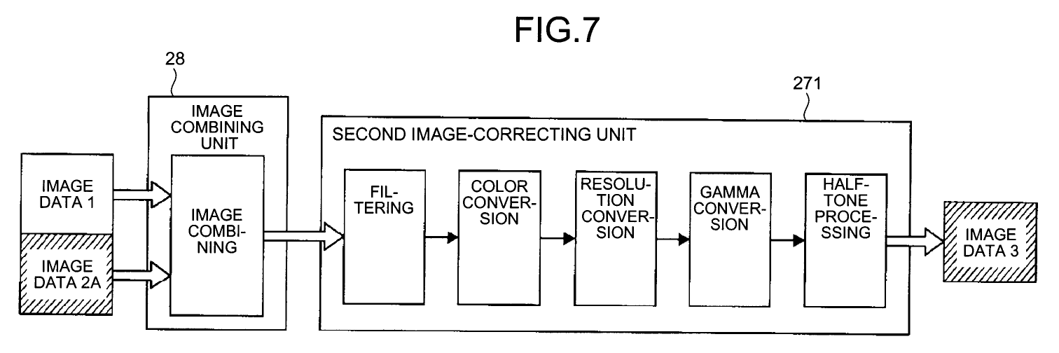

The processes performed at step S44 will be described in detail below. FIG. 7 is a drawing illustrating a correction process performed on combined image data by the second image-correcting unit 271.

In the output correction in the second image-correcting unit 271, filtering, color conversion, resolution conversion, gamma conversion, halftone processing are performed in the order indicated here. It should be noted that in the following description the output correction will be described where the combined image data is printed out from the output unit 30.

In the filtering, for example when the combined image data is output from the output unit 30, the sharpness and the SN ratio thereof are so adjusted that the reproducibility of the combined image data is enhanced. More specifically, for example, when the combined image data is text data, the sharpness of the combined image data may be so enhanced that each character is reproduced clearly. When the combined image data is, for example, a photograph, a smoothing process may be so performed that smooth gradation is obtained.

In the color conversion, the AdobeRGB color space is converted to the CMYK color space that supports outputting to the output unit 30. In the conversion process, the second image-correcting unit 271 may, for example, adjust at the same time the color saturation that has been set by the user.

In the resolution conversion, the resolution of the combined image data of which the color space is converted to the CMYK color space is so converted that the resolution thereof is in accordance with the performance of the output unit 30. In the present embodiment, the resolution of the combined image data is in accordance with the performance of the output unit 30 so that the resolution is not converted.

In the gamma conversion, the gamma characteristic of the combined image data of which the color space is converted to the CMYK color space is so adjusted that the gamma characteristic thereof is in accordance with the characteristic of the output unit 30.

In the halftone processing, the halftone processing based on the halftone processing performance of the output unit 30 is performed to the combined image data of which the color space is converted to the CMKY color space. For example, when the combined image data is an 8-bit data piece each for the CMYK, in the present embodiment, combined image data may be adjusted to be a 2-bit data piece each for the CMYK, and the error diffusion method, which is one of the pseudo halftone processing, may be employed.

Thus, the combined image data that is obtainied by combining the image data 1 and 2A is subjected to output correction to be image data 3. The image data 3 is output from the image forming apparatus 100.

Thus, by performing the output correction as needed for the output of the combined image data, optimum output correction for the output method of the combined image data can be performed. Consequently, the image quality of the output combined image data can be enhanced significantly.

The output correction when the combined image data is transmitted by fax via the circuit I/F unit 62 will be described.

In the image forming apparatus 100, when an operation is so performed as to instruct by the operating unit 50 to transmit the combined image data by fax, the second image-correcting unit 271 corrects the combined image data that has been combined in the image combining unit 28 to be in accordance with fax transmission. The output correction of the combined image data for fax transmission will be described below.

In the filtering, the sharpness of the combined image data is so adjusted that the reproducibility thereof for fax transmission is enhanced.

In the color conversion, the combined image data is converted to be single color (monochrome) 8-bit image data, which is generally used in fax devices.

In the resolution conversion, the combined image data that has been converted to monochrome image data in the color conversion is now converted so that the resolution thereof is in accordance with transmitting and can be received by fax. In the present embodiment, the combined image data is so converted that a resolution for the main scanning is 200 dpi and a resolution for the sub scanning is 100 dpi.

In the gamma conversion, the gamma characteristic of the combined image data that has been converted to monochrome is so adjusted that the reproducibility for fax transmission is enhanced. For example, adjustment may be so performed that the contrast is enhanced in such a way that characters are clearly recognized. When the combined image data is a photograph and the like, the combined image data is so adjusted that the gradation expression thereof becomes smooth.

In the halftone processing, halftone processing is performed based on the halftone processing performance of the fax device. In the present embodiment, the monochrome 8-bit image data may be processed to be binary data by using the error diffusion method, which is one of the pseudo halftone processing.

The output correction will be described when the combined image data is scanner-transmitted to an external device connected to a network via the external I/F unit 64.

What is meant here by the scanner-transmission represents transmission of image data accumulated in the image forming apparatus 100 to an external device connected to the image forming apparatus 100 via a network. What is meant by an external device represents, for example, a computer. With respect to transmission of image data to a computer, a plurality of pieces of image data may be transmitted at a time, or the image forming apparatus 100 may transmit image data to a plurality of computers at a time.

In the image forming apparatus 100, when the operating unit 50 operates to instruct to scanner-transmit the combined image data, the second image-correcting unit 271 performs an output correction so that the combined image data that has been combined in the image combining unit 28 is corrected to be in accordance with the scanner-transmission. The output correction of the combined image data for the scanner-transmission will be described below.

In the filtering, the sharpness of the combined image data is so adjusted that the reproducibility thereof for the scanner-transmission is enhanced.

In the color conversion, the color space of the combined image data is converted to a predetermined color space. In the present embodiment, the predetermined color space is the sRGB color space, which is generally used for scanner-transmission. The color space of the combined image data has been set to the AdobeRGB, consequently the AdobeRGB color space is now converted to be an 8-bit data piece each for the sRGB.

In the resolution conversion, the combined image data is so converted that the resolution thereof is in accordance with transmitting and receiving through the scanner transmission. In the present embodiment, the combined image data is so converted that a resolution for the main scanning is 200 dpi and a resolution for the sub scanning is 200 dpi.

In the gamma conversion, the gamma characteristic of the combined image data is so adjusted that the reproducibility thereof for the scanner-transmission is enhanced. Now in the present embodiment, the combined image data has been set to the sRGB color space image data and has already been matched with a standardized color space. Consequently no gamma conversion is performed.

In the halftone processing, the halftone processing is performed based on the halftone processing performance for transmitting or receiving through the scanner-transmission. In the sRGB specification, 160,000-color 8-bit RGB has been specified. Consequently, in the present embodiment, the gradation is not adjusted.

In the correction of the color space at step S42 of the present embodiment, by correcting the color space as well as correcting a certain color, a certain section of the output image data after the combination can be emphasized.

For example, the second image-correcting unit 271 so performs a process that black image data is replaced with red image data as well as the color space conversion process. The color to be replaced may be determined by the user, for example, when the user gives an instruction to combine the image data at step S41.

Thus, by the separate color adjustment for each piece of image data, a demand by the user can be supported in a precise manner for the output of the combined image data.

As described above, in the present embodiment, when the output of the image data accumulated in the image forming apparatus 100 and of the combined image data thereof is reproduced, alteration of user's demand is supported for reproduction of the output for each piece of image data and optimum correction can be performed. The image forming apparatus 100 can also perform output corrections in accordance with the output method of the combined image data. In the present embodiment, before the two pieces of image data are combined, corrections for each piece of image data are performed separately. Consequently, the combined image data in accordance with user's demand can be generated for combining the image data.

Second to sixth embodiments of the present invention will be described below. Each embodiment, including the first embodiment, is categorized according to the process at step S42.

A second image-correcting unit of the second embodiment corrects the image data 2 to be in accordance with the image data 1 at step S42. On the contrary, second image-correcting units of each of the third to sixth embodiments corrects each of the image data 1 and 2 so that the both can be appropriately combined.

According to the second embodiment, the image forming apparatus 100 includes a second image-correcting unit 272 instead of the second image-correcting unit 271. Moreover, the processes performed at steps S42 and S44 of FIG. 5 are different from the corresponding processes in the first embodiment so that only the processes performed at steps S42 and S44 will be described below. The components having same of similar configuration or same or similar functions will be denoted with same reference numerals.

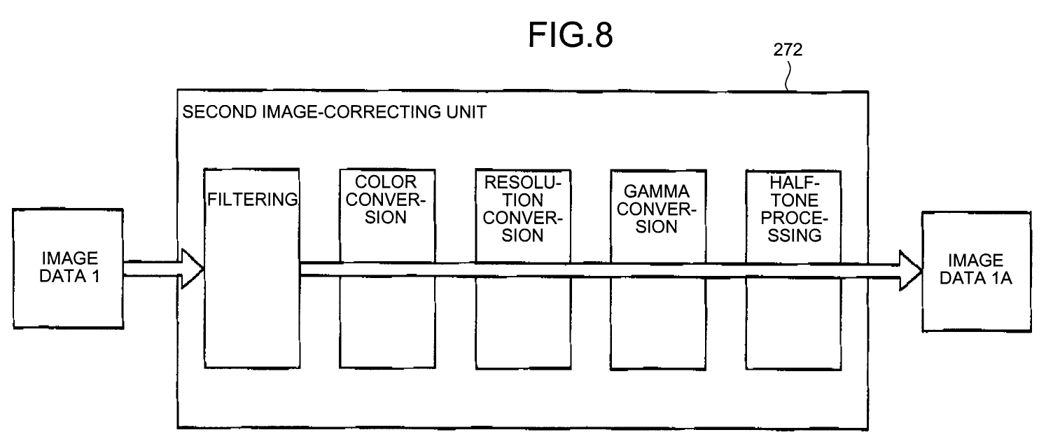

FIG. 8 is a drawing illustrating a correction process performed on image data by the second image-correcting unit 272. In the second embodiment, the spatial frequency characteristics of the image data 1 is corrected to be in accordance with the spatial frequency characteristics of the image data 2.

At step S42, the second image-correcting unit 272 performs filtering of the image data 1 so that the spatial frequency characteristics thereof is in accordance with the spatial frequency characteristics of the image data 2. What is meant here by the filtering represents, for example, adjusting the sharpness and the SN ratio of the image data 1. More specifically, when the image data 1 is text data, the sharpness thereof may be so enhanced that each character is reproduced clearly. When the image data 1 is for example a photograph, smooth processing may be so performed to obtain smooth gradation.

By thus correcting the spatial frequency characteristic, the image data 1 is corrected to be image data 1A. The image data 1A is stored temporarily in the HDD 40.

Thus corrected image data 1A and 2 are loaded from the HDD 40 to the memory 24 by the CPU 22, and are combined by the image combining unit 28 at step S43. It should be noted that in the combining process at step S43 in the present embodiment the combination is performed by overwriting of the image data 2 with the image data 1A.

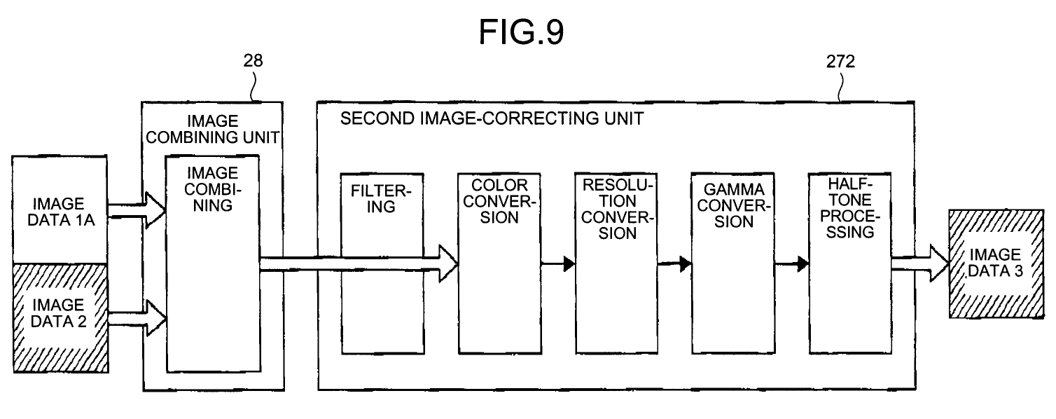

FIG. 9 is a drawing illustrating a correction process performed on combined image data by the second image-correcting unit 272. In the following description, the output correction where the combined image data is printed out from the output unit 30 will be described.

In the output correction in the image combining unit 28, the filtering has been performed to the image data 1A at step S42, and no filtering is necessary because the image data 2 is obtained from a computer. Consequently, no filtering is performed here.

In the present embodiment, the processes performed in the second image-correcting unit 272 after the filtering, from color conversion to halftone processing, are the same as in the first embodiment, thus the descriptions thereof are omitted.

The combined image data that is obtained by combining the image data 1A and 2 is subjected to output correction to be the image data 3. The image data 3 is output from the image forming apparatus 100.

Thus, by performing the output correction for the output of the combined image data, optimum output correction is performed in accordance with the output method of the combined image data. Consequently, the quality of the output combined image data can be significantly enhanced.

The output correction when the combined image data according to the present embodiment is fax transmitted or scanner-transmitted is similar to that in the first embodiment except that no filtering is performed like the output correction for printing out. Consequently, the descriptions thereof are omitted here.

The third embodiment of the present invention will be described below. According to the third embodiment, the image forming apparatus 100 includes a second image-correcting unit 273 instead of the second image-correcting unit 271. Moreover, the processes performed at steps S42 and S44 of FIG. 5 are different from the corresponding processes as in the first embodiment. Thus, only the processes performed at step S42 and S44 will be described here. With respect to various components included in the image forming apparatus 100, the same reference numerals are used to denote the same components as in the first embodiment, and the descriptions thereof are omitted.

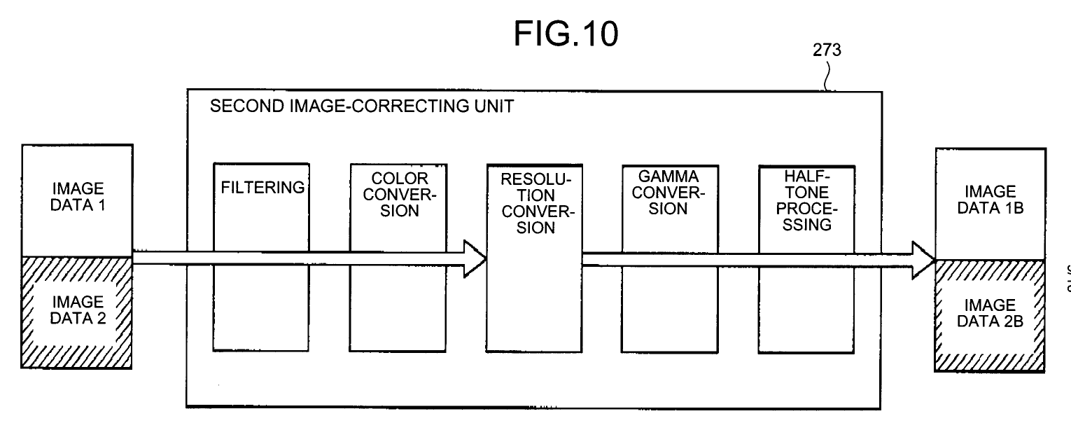

The process performed at step S42 of the present embodiment will be described below. FIG. 10 is a drawing illustrating a correction process performed on image data by the second image-correcting unit 273.

In the present embodiment, the resolutions of the image data 1 and 2 are corrected in such a way that both image data can be appropriately combined. In the present embodiment, the resolutions of the image data 1 and 2 are corrected to be a predetermined resolution.

The second image-correcting unit 273 converts the resolutions of the image data 1 and 2 to be a predetermined resolution at step S42. In the present embodiment, the predetermined resolution is set to, for example, 600 dpi. When the resolution of the image data 1 is converted to be the predetermined resolution, then the image data 1 is referred to as image data 1B. When the resolution of the image data 2 is converted to the predetermined resolution, then the image data 2 is referred to as the image data 2B. The image data 1B and 2B is temporarily stored in the HDD 40.

The corrected image data 1B and 2B are loaded from the HDD 40 to the memory 24 by the CPU 22 and are combined by the image combining unit 28 at step S43. The combining includes overwriting the image data 1B with the image data 2B.

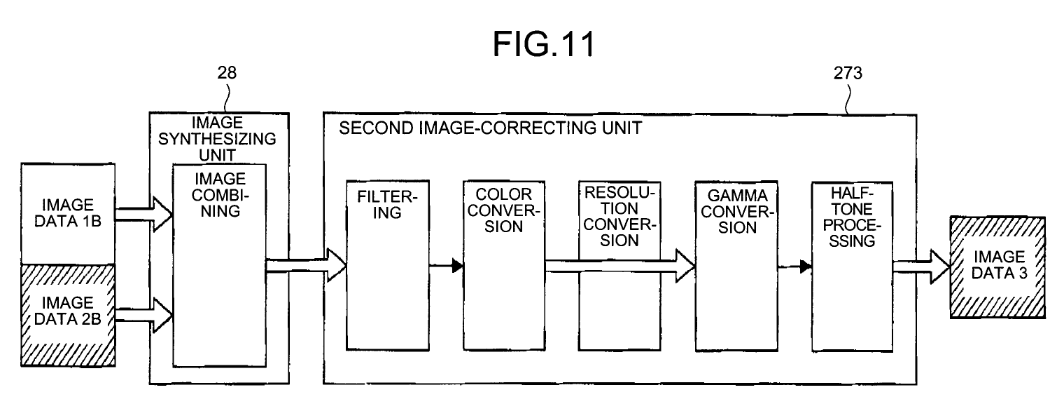

The process performed at step S44 of the present embodiment will be described in detail. FIG. 11 is a drawing illustrating a correction process performed on combined image data by the second image-correcting unit 273.

In the output correction in the image combining unit 28, no resolution conversion is performed since the resolutions of the image data 1 and 2 have been changed at step S42 to be an optimum value for printing out. The other processes are performed in the successive order shown here: filtering, color conversion, gamma conversion, and halftone processing. In the present embodiment, the other processes except the resolution conversion are the same as in the first embodiment, thus the descriptions thereof are omitted.

The combined image data that is obtained by combining the image data 1B and 2B is subjected to output correction and is referred to as the image data 3. The image data 3 is output from the image forming apparatus 100.

Thus, by performing the output correction as needed for the output of the combined image data, optimum output correction is obtained in accordance with the output method of the combined image data. Consequently, the quality of the output combined image data can be significantly enhanced.

The process in which the combined image data is transmitted by fax in the present embodiment will be described.

In the present embodiment, when the combined image data is transmitted by fax, the resolutions of the image data 1 and 2 are converted to an optimum resolution for fax transmission. In the present embodiment, the combined image data is so converted that a resolution for the main scanning is 200 dpi and a resolution for the sub scanning is 100 dpi.

The output correction when the combined image data is transmitted by fax is the same as in the first embodiment except that no resolution conversion is performed. Consequently, the descriptions thereof are omitted.

The process in which the combined image data is scanner-transmitted in the present embodiment will be described.

In the present embodiment, when the combined image data is scanner-transmitted, the resolutions of the image data 1 and 2 are converted to an optimum resolution for scanner-transmission. In the present embodiment, the optimum resolution is set to 200 dpi.

The output correction when the combined image data is scanner-transmitted is the same as in the first embodiment except that no resolution conversion is performed. Thus, the description thereof is omitted.

In the present embodiment, separatedy adjusting to be the predetermined resolution each resolution of the image data 1 and 2 that are to be combined allows provision of optimum combined image data for print-out, fax transmission, and scanner-transmission without any manual intervention by the user.

The fourth embodiment of the present invention will be described below. According to the fourth embodiment, the image forming apparatus 100 includes a second image-correcting unit 274 instead of the second image-correcting unit 271 of the first embodiment. Moreover, the processes performed at step S42 and S44 of FIG. 5 are different from the corresponding processes performed in the first embodiment. Thus, only the processes performed at step S42 and S44 will be described. With respect to various components included in the image forming apparatus 100, the same reference numerals are used to denote the same parts and acts as in the first embodiment, and the descriptions thereof are omitted.

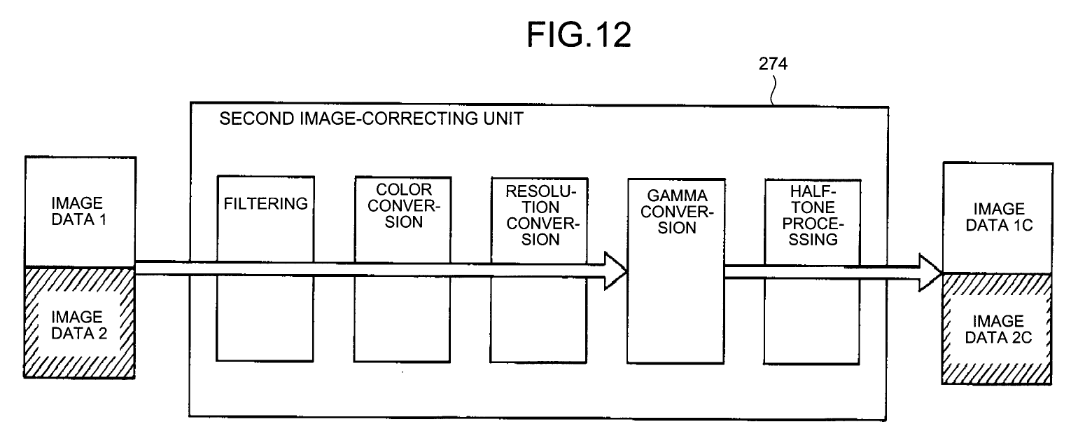

The processes performed at step S42 of the present embodiment will be described below. FIG. 12 is a drawing illustrating a correction process performed on image data by the second image-correcting unit 274.

In the present embodiment, the densities of the image data 1 and 2 are corrected in such a way that both image data can be appropriately combined. In the present embodiment, the densities of the image data 1 and 2 are corrected to be a predetermined density.

It should be noted that the predetermined density may be, for example, determined by the user. The density determined by the user may be, for example at step S41, determined at the same time while the user gives an instruction to combine image data. Instead, the information regarding the predetermined density may be retained in the setting retaining unit 70 as the predetermined density.

The second image-correcting unit 274 converts the densities of the image data 1 and 2 to the predetermined density by the gamma conversion at step S42. In the present embodiment, the image data 1 is converted to the image data 1C by the conversion of the density thereof to the predetermined density, and the image data 2 is converted to the image data 2C by the conversion of the density thereof to the predetermined density. The image data 1C and 2C may be stored temporarily in the HDD 40.

The corrected image data 1C and 2C are loaded from the HDD 40 to the memory 24 by the CPU 22 and are combined by the image combining unit 28 at step S43. The combining includes overwriting of the image data 1C with the image data 2C.

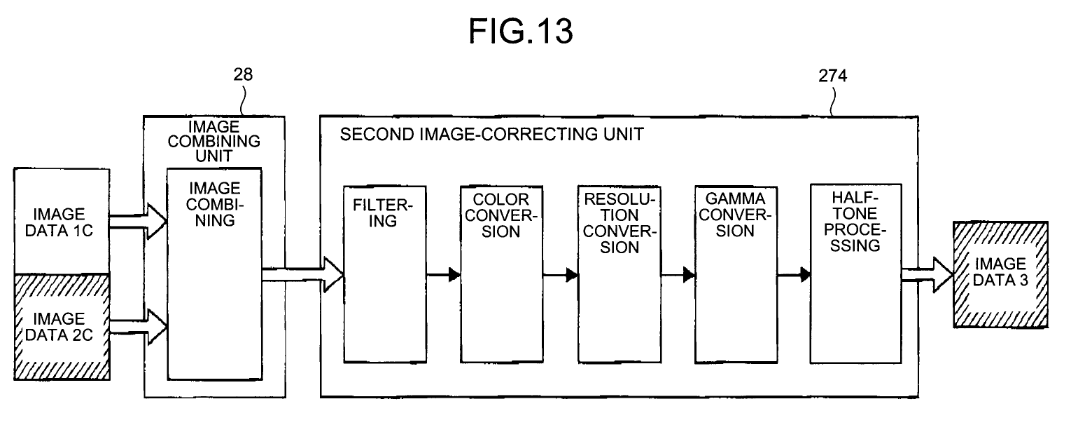

The process performed at step S44 of the present embodiment will be described in detail. FIG. 13 is a drawing illustrating a correction process performed on combined image data by the second image-correcting unit 274. The output correction here is the same as in the first embodiment so that the description thereof is omitted.

When the combined image data is transmitted by fax of the present embodiment, the densities of the image data 1 and 2 may be converted to a higher value at step S42 so that the image data 1 and 2 are optimum for fax transmission. The output correction when the combined image data is transmitted by fax is the same as in the first embodiment, thus the description thereof is omitted.

Further, when the combined image data in the present embodiment is scanner transmitted, the densities of the image data 1 and 2 may be converted at step S42 to a higher value so that the densities thereof are optimum after the scanner-transmission. The output correction when the combined image data is scanner-transmitted is the same as in the first embodiment, thus the description thereof is omitted.

In the present embodiment, separate adjustment of each density of the image data 1 and 2 that are to be combined to be the density determined by the user allows provision of optimum combined image data for print-out, fax transmission, and scanner-transmission without any manual intervention by the user.

In the gamma conversion at step S42 of the present embodiment, the background levels of the image data 1 and 2 may be adjusted. The second image-correcting unit 274 may convert the background levels of the image data 1 and 2 to a predetermined level at step S42 by the gamma conversion. The predetermined level may be for example determined at step S41 at the same time while the user gives an instruction to combine image data. Instead, the information regarding the predetermined background level may be retained in the setting retaining unit 70 as the predetermined background level.

Separate adjustment of the background levels of the image data 1 and 2 that are to be combined to the background level determined by the user allows the provision of optimum combined image data for print-out, fax transmission, and scanner-transmission without any manual intervention by the user. Thus, the image quality thereof is enhanced.

The fifth embodiment of the present invention will be described below. According to the fifth embodiment, the image forming apparatus 100 includes a second image-correcting unit 275 instead of the second image-correcting unit 271 of the first embodiment. Moreover, the processes performed at step S42 and S44 of FIG. 5 are different from the corresponding processes in the first embodiment. Thus, only the processes performed at step S42 and S44 will be described. With respect to various components included in the image forming apparatus 100, the same reference numerals are used to denote the same components as in the first embodiment, and the descriptions thereof are omitted.

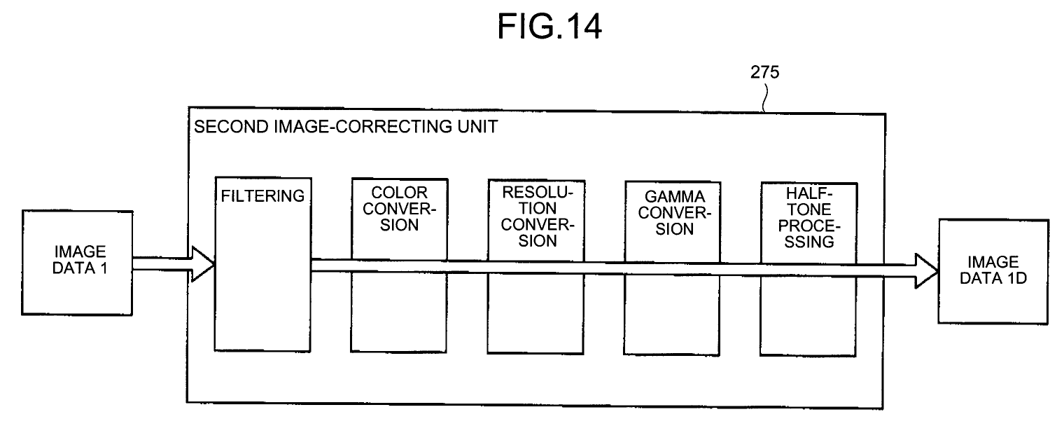

At step S42 of the present embodiment, the image data 1 and 2 are corrected differently. Mainly the image data 2 is corrected to be in accordance with the image data 1. The processes performed at step S42 of the present embodiment will be described in detail below. FIG. 14 is a drawing illustrating a correction process performed on image data 1 by the second image-correcting unit 275.

The second image-correcting unit 275 applies filtering to the image data 1 at step S42 and corrects the spatial frequency characteristic of the image data 1 so that the spatial frequency characteristic thereof is identical to the spatial frequency characteristics of the image data 2. Thus, the image data 1 is corrected to be image data 1D. The image data 1D is temporarily stored in the HDD 40.

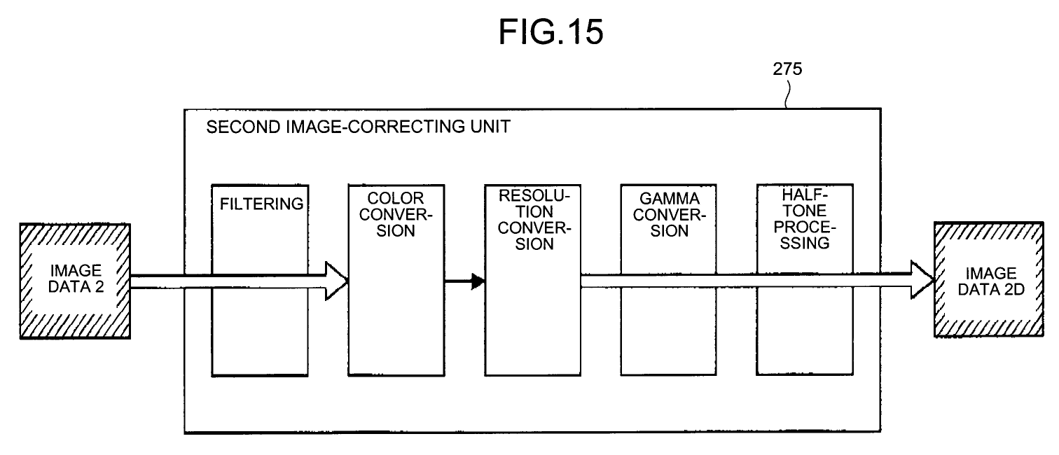

The second image-correcting unit 275 performs color conversion and resolution conversion to the image data 2 at step S42, resulting that the color space and the resolution of the image data 2 are corrected to be identical to the color space and the resolution of the image data 1, respectively. FIG. 15 is a drawing illustrating a correction process performed on image data 2 in the second image-correcting unit 275.

In the second image-correcting unit 275, first, the color space of the image data 2 is converted from the sRGB color space to the AdobeRGB color space. Next, the resolution of the image data 2 is changed to 600 dpi. Thus, the image data 2 is corrected to be image data 2D. The image data 2D is temporarily stored in the HDD 40.

The corrected image data 1D and 2D are loaded from the HDD 40 to the memory 24 by the CPU 22 and are combined by the image combining unit 28 at step S43. It should be noted that in the combining process at step S43, the image data 1D and 2D are combined by overwriting of the image data 1D with the image data 2D.

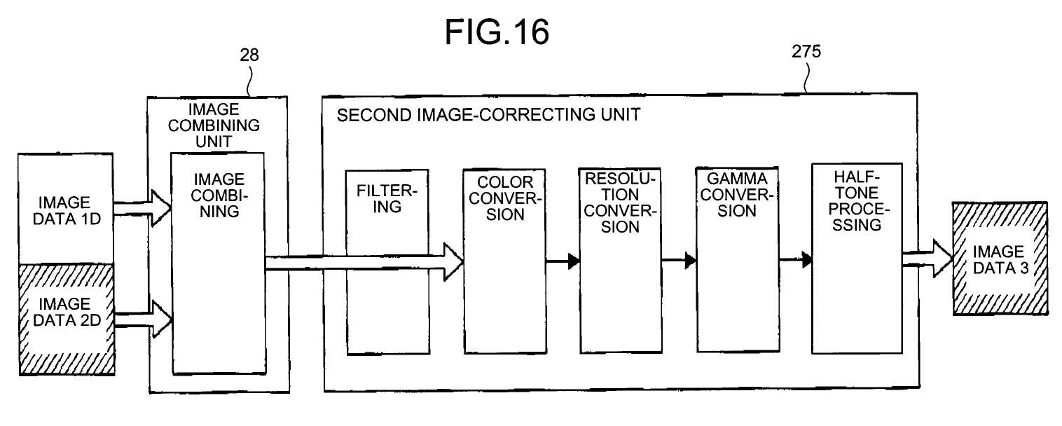

The processes performed at step S44 of the present embodiment will be described in detail below. FIG. 16 is a drawing illustrating an example of the output correction of the combined image data in the second image-correcting unit 275. It should be noted that the output correction when the combined image data is printed out from the output unit 30 will be described.

In the present embodiment, the image data 1D has been applied with the filtering at step S42, and because the image data 2D is obtained from a computer no filtering is necessary so that no filtering is performed here.

In the present embodiment, the processes performed in the second image-correcting unit 275 after the filtering, from color conversion to halftone processing, are the same as in the first embodiment, thus the descriptions thereof are omitted.

The combined image data that is obtained by combining image data 1D and 2D is subjected to output correction to be image data 3. The image data 3 is output from the image forming apparatus 100.

Thus, by performing the output correction for the output of the combined image data, optimum output correction is achieved in accordance with the output method of the combined image data. Consequently, the quality of the output combined image data can be significantly enhanced.

The output correction when the combined image data according to the present embodiment is fax transmitted or scanner-transmitted is similar to that in the first embodiment except that no filtering is performed like the output correction for printing out. Consequently, the descriptions thereof are omitted here.

Thus, in the image forming apparatus 100 of the present embodiment, image data is corrected by a combination of processes described in the embodiments above, thereby generating combined image data. Further in the present embodiment, each piece of image data to be combined is corrected by performing different processes, thus each piece of image data to be combined is corrected separately.

The sixth embodiment of the present invention will be described below. According to the sixth embodiment, the image forming apparatus 100 includes a second image-correcting unit 276 instead of the second image-correcting unit 271 of the first embodiment. Moreover, the processes performed at step S42 and S44 of FIG. 5 are different from the corresponding processes in the first embodiment. Thus, only the processes performed at step S42 and S44 will be described. With respect to various components included in the image forming apparatus 100, the same reference numerals are used to denote the same components as in the first embodiment, and the descriptions thereof are omitted.

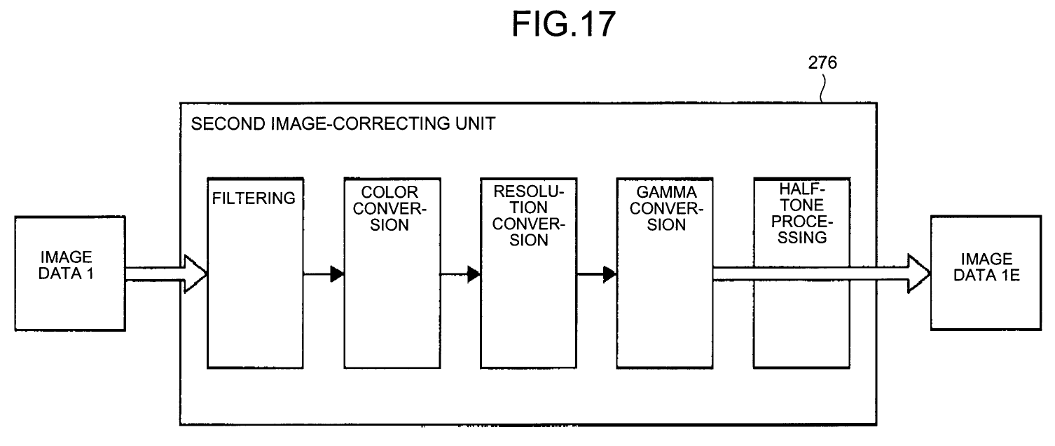

At step S42 of the present embodiment, the image data 1 and 2 are corrected differently. Mainly the image data 1 is corrected to be in accordance with the image data 2. The processes performed at step S42 of the present embodiment will be described in detail below. FIG. 17 is a drawing illustrating an example of the correction of the image data 1 in the second image-correcting unit 276.

The second image-correcting unit 276 corrects the image data 1 at step S42 by performing filtering, color conversion, resolution conversion, and gamma conversion in the successive order indicated here.

In the filtering, the spatial frequency characteristic of the image data 1 is corrected to be identical to the spatial frequency characteristics of the image data 2. In the color conversion, the color space of the image data 1 is converted from the AdobeRGB color space to the sRGB color space that is the color space of the image data 2. In the resolution conversion, the resolution of the image data 1 is converted to a predetermined resolution based on the performance of the output unit 30. Here, the predetermined resolution is 600 dpi. Because the resolution of the image data 1 is also 600 dpi, the resolution is not converted as a matter of fact. In the gamma conversion, the density of the image data 1 is converted to be the same as the density of the image data 2.

Thus, the image data 1 is corrected to be image data 1E. The image data 1E is temporarily stored in the HDD 40.

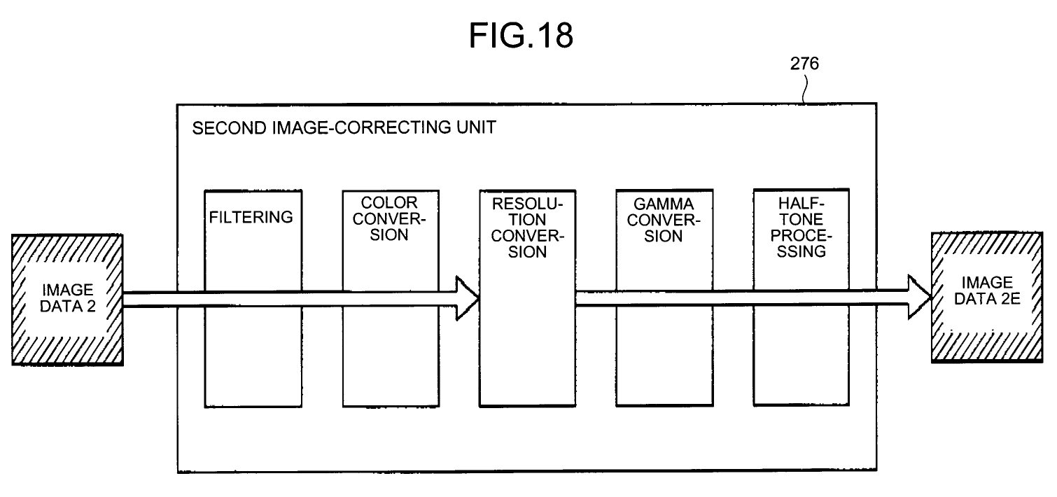

The second image-correcting unit 276 performs the resolution conversion to the image data 2 at step S42, thereby correcting the resolution of the image data 2 so that the resolution thereof becomes the same as the resolution of the image data 1. FIG. 18 is a drawing illustrating a correction process performed on image data 2 by the second image-correcting unit 276. The resolution of the image data 2 is converted to 600 dpi in the present embodiment. Thus, image data 2 is converted to be image data 2E. The image data 2E is temporarily stored in the HDD 40.

The corrected image data 1E and 2E are loaded from the HDD 40 to the memory 24 by the CPU 22 and are combined by the image combining unit 28 at step S43. It should be noted that in the combining process at step S43, the image data 1E and 2E are combined by overwriting of the image data 2E with the image data 1E.

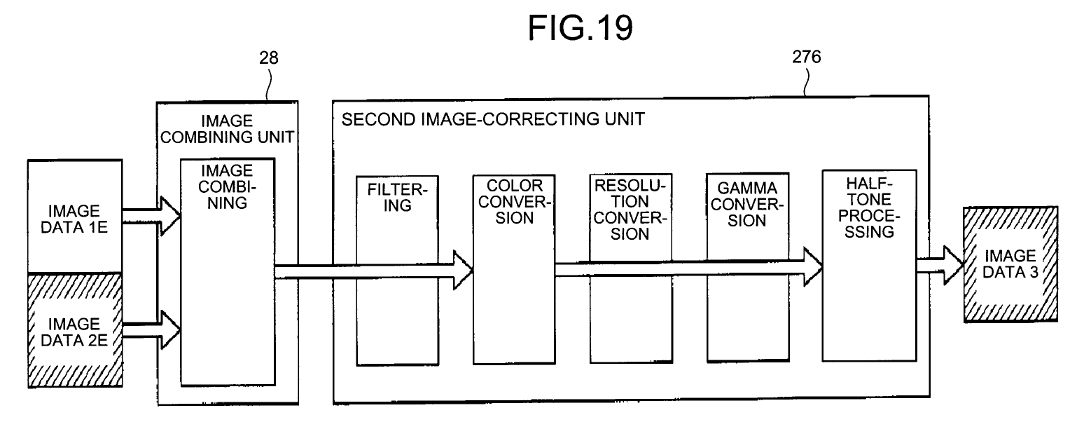

The processes performed at step S44 of the present embodiment will be described in detail below. FIG. 19 is a drawing illustrating a correction process performed on combined image data by the second image-correcting unit 276. It should be noted that the output correction when the combined image data is printed out from the output unit 30 will be described.

In the present embodiment, the image data 1E is subjected to filtering at step S42, and the image data 2E is obtained from a computer with the result that no filtering in necessary. Thus, no filtering is performed here.

In the present embodiment, the resolutions of the image data 1 and 2 are so converted that both resolutions are identical to each other with the result that no resolution conversion is performed here. Further, in the present embodiment, the density of the image data 1 is so converted that the density thereof is identical to the density of the image data 2 with the result that no gamma conversion is performed in the output correction of step S44.

Consequently, the processes performed in the output correction of the present embodiment are color conversion and halftone processing, and these processes are the same as in the first embodiment. Thus, the descriptions thereof are omitted.

When the combined image data of the present embodiment is transmitted by fax, in the resolution conversion of the image data 1 and in the resolution conversion of the image date 2 at step S42, the resolution of each piece of the image data may be so converted that a resolution for the main scanning is 200 dpi and a resolution for the sub scanning is 100 dpi. Similarly, in the output correction when the combined image data of the present embodiment is scanner-transmitted, in the resolution conversion of the image data 1 and in the resolution conversion of the image date 2 at step S42, the resolution of each piece of the image data may be so converted that the resolution thereof is 200 dpi.

With respect to the output corrections when in the present embodiment the combined image data is transmitted by fax and when the combined image data is scanner-transmitted, only the color conversion and the halftone processing are performed, similar to the output correction when the combined image data is printed out. The color conversion and the halftone processing are the same as in the first embodiment, thus the descriptions thereof are omitted.

Thus, in the image forming apparatus 100 of the present embodiment, image data is corrected by a combination of the processes described in the embodiments above, thereby generating combined image data. Further in the present embodiment, each piece of the image data to be combined is corrected by performing different processes, thus each piece of the image data to be combined is corrected separately.

While various descriptions based on each embodiment are provided above, the present invention is not limited to the elements described hereinabove, such as the configurations, the orders, and the combinations of other elements described in the embodiments hereinabove. In this regard, other variations may be made without departing from the true spirit of the present invention and may be specified in accordance with applications thereof.

According to some aspects of the present invention, alteration of the user's demand for each piece of image data when the output of the image data is reproduced is supported, and when the output of the combined image data is produced, optimum correction can be made for each piece of the combined image data.

According to such a configuration, when the outputs of the image data stored in the image forming apparatus and of the combined image data thereof are reproduced, alteration of the user's demand according to each piece of image data for the reproduction of the output the image data can be supported and optimum correction is also performed.

According to such a configuration, when the image data stored in the image forming apparatus is combined, the combined image data is separately corrected, with a result that alteration of the user's demand is supported according to each piece of image data for the reproduction of the output thereof and optimum combined image data can be output.

According to such a configuration, when the combined image data is output from the image forming apparatus, the image data can be corrected to be optimum data for an output method according to the application of the image data.

According to such a configuration, the color spaces of the two pieces of image data before being combined can be separately corrected.

According to such a configuration, the spatial frequency characteristics of the two pieces of image data before being combined can be separately corrected.

According to such a configuration, the resolutions of the two pieces of image data before being combined can be separately corrected.

According to such a configuration, the densities of the two pieces of image data before being combined can be separately corrected.

According to such a configuration, the background levels of the two pieces of image data before being combined can be separately corrected.

According to such a configuration, the colors of the two pieces of image data before being combined can be separately corrected.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising: a scanning unit that scans documents to produce a first image data and a second image data;
a correcting unit that corrects at least one of the first image data and the second image data; and
a combining unit that combines raw or corrected first image data and the second image data.

2. The image forming apparatus according to claim 1, further comprising a storage unit that stores therein third image data, wherein
the correcting unit corrects the first image data, and
the combining unit combines corrected first image data and the third image data.

3. The image forming apparatus according to claim 1, further comprising a storage unit that stores therein third image data, wherein
the correcting unit corrects the third image data, and
the combining unit combines the first image data and corrected third image data.

4. The image forming apparatus according to claim 1, further comprising a storage unit that stores therein third image data, wherein
the correcting unit corrects the first image data and the third image data, and
the combining unit combines corrected first image data and corrected third image data.

5. The image forming apparatus according to claim 1, further comprising an output unit configured to output image data, wherein
the correcting unit corrects combined image data so that resulting image data is output by the output unit.

6. The image forming apparatus according to claim 1, wherein the correcting unit corrects a color space of image data.

7. The image forming apparatus according to claim 1, wherein the correcting unit corrects spatial frequency characteristics of image data.

8. The image forming apparatus according to claim 1, wherein the correcting unit corrects a resolution of image data.

9. The image forming apparatus according to claim 1, wherein the correcting unit corrects a density of image data.

10. The image forming apparatus according to claim 1, wherein the correcting unit corrects a background level of image data.

11. The image forming apparatus according to claim 1, wherein the correcting unit corrects a color of image data.
